(19) United States
(12) Patent Application Publication
(10) Pub. No.: US 2023/0169363 A1
(43) Pub. Date: Jun. 1, 2023

(54) AUTOMATICALLY GENERATING FACTSHEETS FOR ARTIFICIAL INTELLIGENCE-BASED QUESTION ANSWERING SYSTEMS

(71) Applicant: International Business Machines Corporation, Armonk, NY (US)

(72) Inventors: Jaydeep Sen, Bangalore (IN); Saneem Ahmed Chemmengath, Bangalore (IN); Vishwajeet Kumar, Bangalore (IN); Samarth Bharadwaj, Bangalore (IN)

(21) Appl. No.: 17/538,221

(22) Filed: Nov. 30, 2021

(51) Int. Cl. G06N 5/04; G06F 16/34; G06F 16/383

(52) U.S. Cl. CPC G06N 5/04; G06F 16/345; G06F 16/383

(57) ABSTRACT

Methods, systems, and computer program products for automatically generating factsheets for artificial intelligence-based question answering systems are provided herein. A computer-implemented method includes processing at least one given artificial intelligence-based question answering system on tabular data using at least one test engine; generating, based on the processing, accuracy values attributed to the at least one given artificial intelligence-based question answering system in connection with particular tabular data; generating, based on the processing, a set of queries determined to be addressable by the at least one given artificial intelligence-based question answering system on the particular tabular data; generating, based on the accuracy values and the queries determined to be addressable, at least one human-readable summary of the at least one given artificial intelligence-based question answering system; and performing one or more automated actions based on the at least one human-readable summary.

### BACKGROUND

The present application generally relates to information technology and, more particularly, to data processing techniques. More specifically, artificial intelligence (AI) factsheets are increasingly used to standardize comparisons across different candidate models. As used herein, AI factsheets represent attempts to standardize an information template to capture relevant information about a given model, and are aimed towards promoting trust, transparency and comparison fairness for informed reusability among end users. However, conventional data processing approaches fail to provide an equivalent of AI factsheets for other artificial intelligence-based tools such as, for example, TableQA systems, which take a table and a natural language question answerable over the table and aims to find the correct answer from the table.

### SUMMARY

In one embodiment of the present invention, techniques for automatically generating factsheets for artificial intelligence-based question answering systems are provided. An example computer-implemented method can include processing at least one given artificial intelligence-based question answering system on tabular data using at least one test engine, and generating, based at least in part on the processing of the at least one given artificial intelligence-based question answering system, one or more accuracy values attributed to the at least one given artificial intelligence-based question answering system in connection with particular tabular data. The method also includes generating, based at least in part on the processing of the at least one given artificial intelligence-based question answering system, a set of one or more queries determined to be addressable by the at least one given artificial intelligence-based question answering system on the particular tabular data. Additionally, the method includes generating, based at least in part on the one or more accuracy values and the one or more queries determined to be addressable, at least one human-readable summary of the at least one given artificial intelligence-based question answering system, and performing one or more automated actions based at least in part on the at least one human-readable summary.

Another embodiment of the invention or elements thereof can be implemented in the form of a computer program product tangibly embodying computer readable instructions which, when implemented, cause a computer to carry out a plurality of method steps, as described herein. Furthermore, another embodiment of the invention or elements thereof can be implemented in the form of a system including a memory and at least one processor that is coupled to the memory and configured to perform noted method steps. Yet further, another embodiment of the invention or elements thereof can be implemented in the form of means for carrying out the method steps described herein, or elements thereof; the means can include hardware module(s) or a combination of hardware and software modules, wherein the software modules are stored in a tangible computer-readable storage medium (or multiple such media).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating system architecture, according to an embodiment of the invention;

FIG. 2 is a diagram illustrating system architecture including Universal Test Engine (UTE) architecture, according to an embodiment of the invention;

FIG. 3 is a diagram illustrating a query generation control module, according to an example embodiment of the invention;

FIG. 4 is a flow diagram illustrating techniques according to an example embodiment of the invention;

FIG. 5 is a system diagram of an example computer system on which at least one embodiment of the invention can be implemented;

FIG. 6 depicts a cloud computing environment according to an example embodiment of the invention; and

FIG. 7 depicts abstraction model layers according to an example embodiment of the invention.

### DETAILED DESCRIPTION

As described herein, an embodiment of the present invention includes automatically generating factsheets for artificial intelligence-based question answering systems. By way of example, at least one embodiment can include automatically generating at least one factsheet for one or more question-answering systems (e.g., a TableQA system), on a given table. Such an embodiment includes generating and/or implementing a UTE to test any black box TableQA system S for a varying complexity of questions. Accordingly, in such an embodiment, given a TableQA system S and table T, the UTE produces multiple outputs. For example, such an output can include a determination of the overall accuracy of system S, given table T on auto-generated queries of varying complexity by the UTE, including accuracy across different complexity dimensions. Such an accuracy determination can be measured, for example, on the basis of at least one standardized test bed of natural language questions. Additionally, a UTE output can include example queries that system S is expected to handle on table T. Further, such an embodiment also includes generating a human understandable summary to improve the TableQA system S.

By way merely of example and illustration, such a summary can include a description such as the following: The system handles simple retrieval queries with high accuracy and some simple aggregation queries that clearly mention the aggregations; the system understands natural language paraphrasing but fails to handle queries on abbreviations or paraphrases with non-exact matches; the system does not recognize unanswerable queries, and fails in tables with data volume of more than ~512 cells.

Accordingly, one or more embodiments can include making users familiar with current capabilities of a given TableQA system. Additionally, such an embodiment includes generating and/or utilizing application programming interfaces (APIs) around a given query sheet. As used herein, a query sheet contains a diverse set of queries that a given system has been tested to correctly answer. For example, in inquiring whether system S can handle a particular query Q, an API can be implemented to search for query Q in the given query sheet.

There are various implicit dimensions of an AI-based QA system such as, for example, what types of queries the system can answer, what kind(s) of natural language phrasing the system can recognize, what can be implicitly inferred by the system versus what should be explicitly stated (to the system), and whether the system can detect unanswerable queries. For example, query types can include simple project queries on a single table, select(filter)-project queries on a single table (wherein the filtering can be, e.g., on entity names, numeric comparison, time-based filters, etc.), aggregation-select-project queries on a single table (e.g., operations such as sum, average, maximum, minimum, etc.), aggregation-select-project-join queries on multiple tables, aggregation-select-project-join-group-by/order-by/having queries on multiple tables, nested queries, etc.

Further, natural language phrasing support can present itself with respect to alias phrases such as, for example, “more than 30” and “above 30,” “total amount” and “sum amount,” etc., as well as with respect to the position of arguments such as, for example, “total amount” versus “amount in total.” Also, a system’s implicit capabilities versus its explicit statement needs can be based at least in part, for example, on time filter arguments (e.g., “loans in 2019” versus “loan with start date in 2019”), aggregation arguments (e.g., “average loans” versus “average amount of loans”), and entity linking and/or abbreviations.

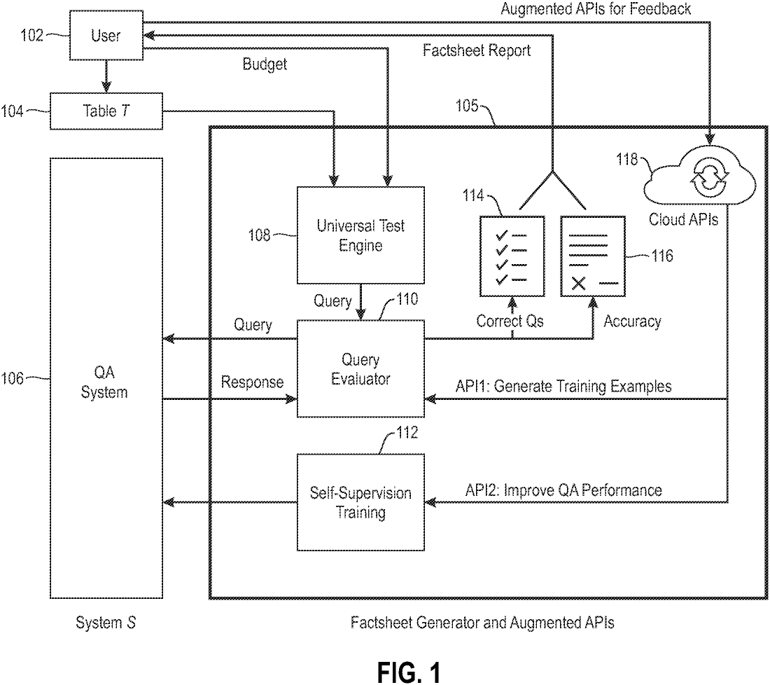

FIG. 1 is a diagram illustrating system architecture, according to an embodiment of the invention. By way of illustration, FIG. 1 depicts, within factsheet generator and augmented APIs 105, universal test engine 108, which takes table T104 as input and generates different categories of questions covering different test cases to produce a uniform test bed QS. The user 102 can provide budget information to universal test engine 108 pertaining to how many such queries can be used to test the QA system S 106, thus assisting in determining the test bed size. All such queries are sent to query evaluator 110 to evaluate the performance of QA system S106 on QS. The output of query evaluator 110 is used to produce two factsheet components: query sheet 114, which captures the queries correctly answered by QA system S106, and an accuracy sheet 116 which describes the performance of QA system S106 on different categories of queries in the test bed. Based on the reports generated by query sheet 114 and accuracy sheet 116, the user 102 may perform cloud-based APIs 118 to improve system performance.

In at least one example embodiment, there may be at least two such high-level APIs, including a generate training example API (API1) and an improve QA performance API (API2). With respect to the generate training example API (API1), the user 102 may provide (to query evaluator 110) his or her own set of training examples to probe more on system performance and/or improve system performance. With respect to the improve QA performance API (API2), the user 102 may initiate a self-supervision-based training example generation mechanism (via self-supervision training component 112) that will generate more training examples on query categories where system S106 failed and, thus, likely improve overall performance of system S106.

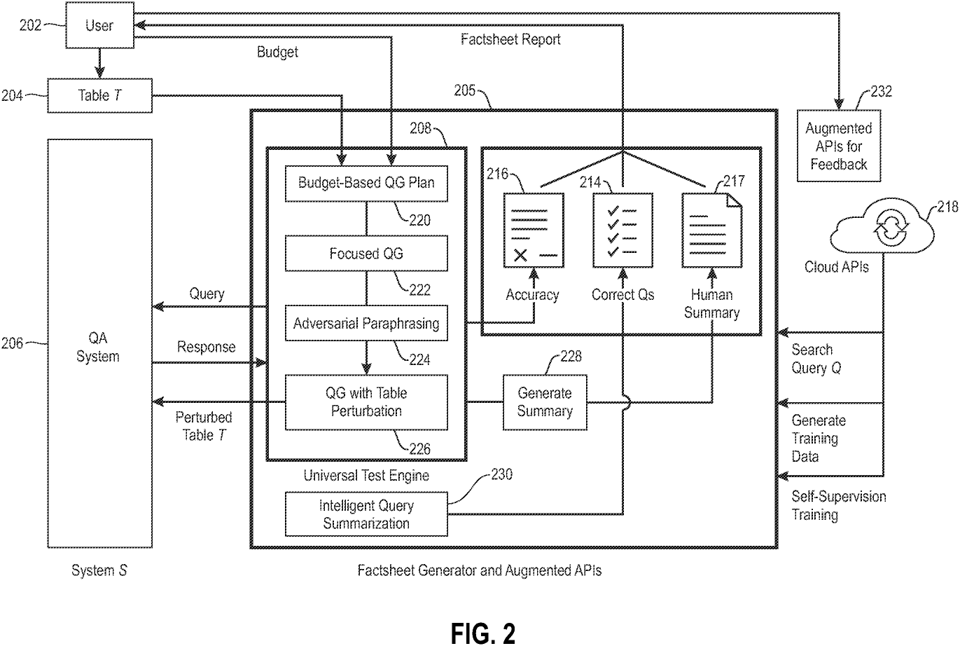

FIG. 2 is a diagram illustrating system architecture including UTE architecture, according to an embodiment of the invention. By way of illustration, FIG. 2 depicts, within factsheet generator and augmented APIs 205, components of universal test engine 208, which aims to generate queries covering different aspects of testing the QA system S206. For example, budget-based query generation (QG) plan 220 intelligently chooses the proportions of different query types depending on the budget information provided by user 202. Focused OG 222 performs focused query generation of different categories that obeys the budget planning decided by component 220. Adversarial paraphrasing 224 aims to introduce paraphrasing of questions generated by component 222 to introduce adversarial noise in natural language queries and test the performance of QA system S206 on understanding and/or handling natural language queries when phrased differently. QG with table perturbation 226 further attempts to test the performance of QA system S206 on different types of tables by perturbing input table T204 to introduce different complexities associated with table structure.

Based on the performance of QA system S206, intelligent query summarization 230 summarizes the performance by selecting a subset of working queries to be put into the query sheet 214, the accuracy report in accuracy sheet 216, and also a human-readable summary 217 on the type of queries working versus those not working in connection with generate summary component 228. The summary 217 is aimed to human users to understand the performance of QA system S 206 through text descriptions. As also depicted in FIG. 2, augmented APIs for feedback 232 can be provided by user 202, and cloud APIs 218 function similarly as described in FIG. 1 in connection with cloud APIs 118.

As detailed herein, at least one embodiment includes focused query generation. Such an embodiment includes generating question and answer pairs associated with given a table. Additionally or alternatively, such an embodiment can include generating questions with one or more tunable controls, which can include using at least one sample structure query language (SQL) for a given table, and translating such SQL content to at least one natural language question. With respect to tunable controls, in one or more embodiments, such controls can include aggregates (e.g., SUM, AVG, COUNT, MIN, MAX, etc.), number of WHERE conditions, nested queries (e.g., group by, having, etc.), inequality conditions (e.g., greater than, less than, not equal, etc.), row order dependence (e.g., first, last, next, etc.), multi-cell versus single cell answers, types of columns and rows to pick (e.g., text versus numerical, column categories identified by named entity recognition (NER), etc.), use of abbreviations and/or synonyms, etc.

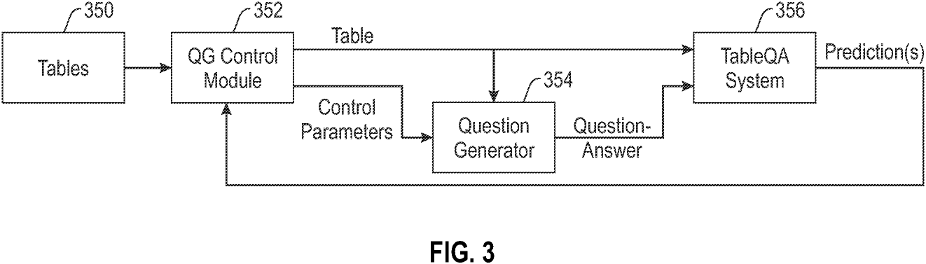

Also, as further described herein (e.g., in connection with FIG. 3 below), one or more embodiments include budget-based smart query distribution. For example, a QG system can generate many (e.g., thousands) questions per table, but testing a TableQA system with all such generated questions might be cost-prohibitive. Accordingly, at least one embodiment can include determining and using a TableQA system on a certain number of instances.

FIG. 3 is a diagram illustrating a query generation control module, according to an example embodiment of the invention. By way of illustration, FIG. 3 depicts a QG control module 352, which, given a list of tables 350 and one or more predictions (from TableQA system 356) on already-generated questions, selects one of the tables and a set of one or more control parameters, which defines what type of question to generate next. The selected table is provided to TableQA system 356, while the set of control parameters is provided to question generator 354, which generates and provides to Table QA system 356 at least one question-answer pair. Additionally, TableQA system 356 can generate, and provide back to QG control module 352, one or more predictions pertaining to the at least one question-answer pair provided by question generator 354.

Question-answer pair generation, in one or more embodiments, can include using a rule-based technique, wherein such an embodiment begins with one or more simple questions, and if the model performs well, then moves on to more complex questions. Alternatively, for example, if the model fails on two-clause questions, such an embodiment will not generate three- or four-clause questions. Also, one or more embodiments can include utilizing a minimum set of types of questions to be covered in connection with a given budget, and selecting tables according to the type(s) of questions to be generated (e.g., size, numerical versus text, etc.). Further, at least one embodiment can include implementing a probabilistic system which estimates how the model would perform on a given type of question by analyzing historical performance. Such an embodiment can include emphasizing the generation of questions which the system is and/or has been uncertain about (with respect to answering historically).

As also detailed herein (e.g., in connection with component 230 in FIG. 2), at least one embodiment includes intelligent query summarization. By way merely of illustration, consider an example use case wherein a user provides a number (e.g., 100) to summarize what types of queries work on the model. In an example embodiment, the summarization should select a subset of working queries (e.g., from UTE-generated queries) such that the example covers all test segments and also are diversified in their type. Accordingly, for each test segment, such an embodiment can include selecting a proportionate number of test cases as in UTE, but scaled using the user-provided budget (i.e., 100). For example, such selections might include 25% simple retrieval test cases, 20% simple aggregation test cases, 15% advanced query test cases, 15% paraphrasing test cases, 15% non-exact match teste cases, and 10% abbreviations test cases. If a particular segment fails completely (e.g., abbreviations test cases), that share of test cases is distributed across all other segments (e.g., distributed equally).

Additionally or alternatively, for each test segment, one or more embodiments can include selecting the subset of queries which have a minimum pairwise overlap of needed properties and operations, to cover the complete test space of input table T. For example, numeric properties which are used in aggregation queries might not be reused to test retrieval queries for budget constraints.

Also, at least one embodiment includes paraphrase generation. Such an embodiment includes masking entity matches with entity type and natural language phrases with specific action operators. For example, such masks can pertain to entities (e.g., a person, a company, etc.), a named entity, a numeric entity, a numerical comparator, an aggregation operator, numbers, etc. Additionally or alternatively, such an embodiment can include masking a natural language query using one or more applicable masks. By way of example, consider the following: “Show me companies in California” can be masked to read as “Show me [Entity] in [NamedE],” and “What is the average salary of persons with an age of more than 30” can be masked to read as “What is the [Aggr] [numE1] of [Entity] with [numE2] [numC] [number].”

One or more embodiments can also include using at least one high-level grammar and/or learning a language model over masked queries such that, for each type of query, a set of masked templates can be implemented to generate queries of that type. Such queries can include, for example, the following: simple project queries on a single table such as, e.g., “Show me [Entity]”; select(filter)-project queries on a single table such as, e.g., “Show me [Entity] of [NamedE] | show me [Entity] with [numE] [numC] [number] |,” etc.; aggregation-select-project queries on a single table such as, e.g., “Show me [aggr] [numE] of [NamedE]”; and aggregation-select-project-join-group-by/order-by/having queries on multiple table such as, e.g., “Show me [aggr] [numE] of [NamedE] by [E] | show me top [number] [entity] by [numE],” etc.

Also, for each masked entity type, at least one embodiment can include varying the possibilities to generate variations of natural language queries from the same template. By way of example, such an embodiment can include introducing non-exact matches by using unique partial words, introducing broader synonyms by using at least one lexical database and/or thesaurus, and/or introducing filter and/or select clause candidates with abbreviated mentions.

Additionally, at least one embodiment includes performance analysis with respect to table perturbations. Given a table T, such an embodiment includes adding a synthetic row r (wherein the value for every column c in r is generated by looking at the data distribution for c in original table T). Such an embodiment also includes adding one or more new columns to the existing table by applying one or more arithmetic operations and/or one or more other aggregate operations over two columns (or more columns if the column values are numeric). A new column can also be added by combining values from two columns with text data.

Further, given a question Q and a table T, one or more embodiments include analyzing trigger words and identifying possible aggregate operations from the question and, depending upon the trigger word, adding a new table column with values returned after an aggregate operation on the columns. By way merely of example, words such as “sum” and “total” can be trigger words of “SUM” type aggregation, whereas words such as “mean,” “avg,” etc. can be trigger words for “AVERAGE” type aggregation. For every column c in table T, at least one embodiment includes using an existing information source (e.g., WordNet, word ontologies, etc.) to determine possible acronyms and/or abbreviations for the column names. A table T can be created with column names replaced by their corresponding abbreviations and/or acronyms. Such an embodiment can include incorporating row headers for every row, and converting table T to table T-prime (T′) by transposing row headers and column headers.

At least one embodiment can also include generating unanswerable queries. Given an answerable question Q and its corresponding table T that directly or indirectly contains the answer A, such an embodiment includes generating an unanswerable question Q′ such that the question cannot be answered using table T directly or indirectly, and the question Q′ must be relevant to question Q and table T. More specifically, generating unanswerable questions can include, for example, clustering tables with similar columns, generating answerable questions using at least one question generation module for each table in a given cluster, and shuffling the questions within a cluster such that the questions attached to a table in the cluster are unanswerable.

As also detailed herein (such as via element 228 in FIG. 2), one or more embodiments include generate summary responses (e.g., a human-readable summary of a given set of tests done). By way of example, such a summary can include tables and/or charts of model performance based at least in part on a sub-set of test instances. In at least one embodiment, generating summary responses can be used to identify interesting and/or consistent patterns of model performance, wherein important and/or salient numbers can be visually represented (e.g., model performance versus aggregate operations). Further, in some embodiments, summary responses can include one or more anecdotal examples of questions and predictions (e.g., examples representing the types of questions wherein the model performs well, examples of questions wherein the model performs unexpectedly (e.g., wherein the model fails on easy questions and/or correctly predicts answers to hard questions)). Additionally or alternatively, one or more embodiments can include using a template-based method to generate summary response text and/or can include using one or more natural language generation (NLG) techniques.

At least one embodiment (e.g., via element 232 in FIG. 2) can additionally include generating and/or implementing one or more augmented APIs. Such an embodiment includes creating an ecosystem around at least one TableQA factsheet for different use cases. By way of illustration, consider a first API pertaining to search operations with respect to model M, table T, and/or natural language query Q. For example, consider a use case for this first API in connection with determining whether M can handle Q given T. If not, then an example embodiment, using the first API, can include providing a closest query Q′ of Q and/or paraphrasing Q to Q′ such that Q′ can be handled by M, given T. If no such Q′ exists, such an embodiment can include retrieving at least one similar query Q″ from example queries in the given factsheet given M, T.

Additionally or alternatively, consider a second API pertaining to obtaining training data for model M and/or table T. For example, consider a use case for this second API wherein a user has external model M and wants to improve the model M with additional training data for better accuracy on T. At least one embodiment can include generating, in connection with the second API, one or more questions on table T using a UTE, and return the question(s) wherein model M failed on T.

Further, consider a third API pertaining to improving a model with respect to table T. For example, consider a use case for this third API wherein the model is internal to a given enterprise, and the user wants to fine-tune the model for table T. At least one embodiment can include using the above-noted second API (e.g., a get_training_data() API) in conjunction with this third API to obtain non-working queries, and using self-supervision techniques with at least a portion of the non-working queries to improve the model.

One or more embodiments can also include deriving answerable queries of a black box natural language interface to database (NLIDB) system. Such an embodiment can include obtaining a sample natural language query q from a list of generated queries from a QA language model, and executing q on S_{D}, wherein S_{D} refers to instantiation of system S on domain D. If q fails, then such an embodiment can include generating a paraphrased version q′ of query q (e.g., using one or more rule-based generation techniques, which can include changing the phrasing or/and position of certain argument words in the query, etc.), and executing q′ on S_{D}. If q′ succeeds, then such an embodiment can include encoding at least one failure rule on why q failed, encoding a rewrite rule that transformed q to q′, adding <q, q′> to at least one set of training data, and adding q′ to a list of answerable queries. Otherwise, if q succeeds in the initial execution attempt, such an embodiment can include adding q to the list of answerable queries, and computing at least one accuracy measurement based, for example, on the number of answered queries divided by the number of queries asked. Additionally, an ultimate output of such an embodiment can include an answerable query list and one or more marked rewrite rules.

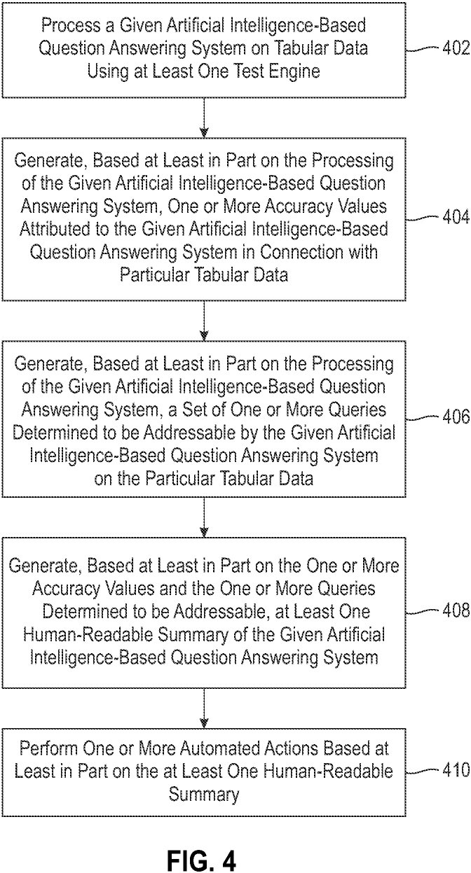

FIG. 4 is a flow diagram illustrating techniques according to an embodiment of the present invention. Step 402 includes processing at least one given artificial intelligence-based question answering system on tabular data using at least one test engine. In at least one embodiment, processing the at least one given artificial intelligence-based question answering system on tabular data using at least one test engine includes testing the at least one given artificial intelligence-based question answering system on the particular tabular data using multiple questions of varying complexity.

Step 404 includes generating, based at least in part on the processing of the at least one given artificial intelligence-based question answering system, one or more accuracy values attributed to the at least one given artificial intelligence-based question answering system in connection with particular tabular data. In one or more embodiments, generating the one or more accuracy values includes generating at least one accuracy value measured on at least one standardized test set of natural language questions.

Step 406 includes generating, based at least in part on the processing of the at least one given artificial intelligence-based question answering system, a set of one or more queries determined to be addressable by the at least one given artificial intelligence-based question answering system on the particular tabular data.

Step 408 includes generating, based at least in part on the one or more accuracy values and the one or more queries determined to be addressable, at least one human-readable summary of the at least one given artificial intelligence-based question answering system. In one or more embodiments, automatically generating the at least one human-readable summary includes determining and outputting one or more suggestions for improving the at least one given artificial intelligence-based question answering system.

In at least one embodiment, processing at least one given artificial intelligence-based question answering system on tabular data using at least one test engine includes processing multiple artificial intelligence-based question answering systems on the tabular data using the at least one test engine, generating, based at least in part on the processing of the multiple artificial intelligence-based question answering systems, a set of one or more queries includes generating a universal test bed of queries determined to be addressable by the multiple artificial intelligence-based question answering systems. Such an embodiment can also include comparing performance of the multiple artificial intelligence-based question answering systems in connection with the universal test bed of queries.

Step 410 includes performing one or more automated actions based at least in part on the at least one human-readable summary. In at least one embodiment, performing the one or more automated actions includes automatically generating, based at least in part on the at least one human-readable summary, one or more application programming interfaces associated with the at least one given artificial intelligence-based question answering system. In such an embodiment, generating one or more application programming interfaces associated with the at least one given artificial intelligence-based question answering system can include generating at least one application programming interface pertaining to search operations with respect to the at least one given artificial intelligence-based question answering system, the particular tabular data, and one or more natural language queries. Additionally or alternatively, generating one or more application programming interfaces associated with the at least one given artificial intelligence-based question answering system can include generating at least one application programming interface pertaining to obtaining training data for at least one of the at least one given artificial intelligence-based question answering system and the particular tabular data. Further, generating one or more application programming interfaces associated with the at least one given artificial intelligence-based question answering system can include generating at least one application programming interface pertaining to modifying and/or improving the at least one given artificial intelligence-based question answering system with respect to the particular tabular data.

In one or more embodiments, performing the one or more automated actions can also include training the at least one given artificial intelligence-based question answering system based at least in part on at least a portion of the at least one human-readable summary. Additionally or alternatively, performing the one or more automated actions can include automatically updating, based at least in part on the at least one human-readable summary, one or more existing application programming interfaces associated with the at least one given artificial intelligence-based question answering system.

Further, in at least one embodiment, software implementing the techniques depicted in FIG. 4 can be provided as a service in a cloud environment.

It is to be appreciated that “model,” as used herein, refers to an electronic digitally stored set of executable instructions and data values, associated with one another, which are capable of receiving and responding to a programmatic or other digital call, invocation, or request for resolution based upon specified input values, to yield one or more output values that can serve as the basis of computer-implemented recommendations, output data displays, machine control, etc. Persons of skill in the field find it convenient to express models using mathematical equations, but that form of expression does not confine the models disclosed herein to abstract concepts; instead, each model herein has a practical application in a computer in the form of stored executable instructions and data that implement the model using the computer.

The techniques depicted in FIG. 4 can also, as described herein, include providing a system, wherein the system includes distinct software modules, each of the distinct software modules being embodied on a tangible computer-readable recordable storage medium. All of the modules (or any subset thereof) can be on the same medium, or each can be on a different medium, for example. The modules can include any or all of the components shown in the figures and/or described herein. In an embodiment of the invention, the modules can run, for example, on a hardware processor. The method steps can then be carried out using the distinct software modules of the system, as described above, executing on a hardware processor. Further, a computer program product can include a tangible computer-readable recordable storage medium with code adapted to be executed to carry out at least one method step described herein, including the provision of the system with the distinct software modules.

Additionally, the techniques depicted in FIG. 4 can be implemented via a computer program product that can include computer useable program code that is stored in a computer readable storage medium in a data processing system, and wherein the computer useable program code was downloaded over a network from a remote data processing system. Also, in an embodiment of the invention, the computer program product can include computer useable program code that is stored in a computer readable storage medium in a server data processing system, and wherein the computer useable program code is downloaded over a network to a remote data processing system for use in a computer readable storage medium with the remote system.

An embodiment of the invention or elements thereof can be implemented in the form of an apparatus including a memory and at least one processor that is coupled to the memory and configured to perform exemplary method steps.

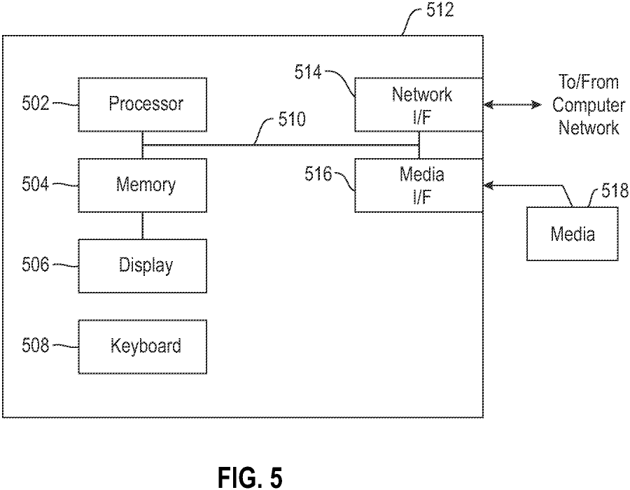

Additionally, an embodiment of the present invention can make use of software running on a computer or workstation. With reference to FIG. 5, such an implementation might employ, for example, a processor 502, a memory 504, and an input/output interface formed, for example, by a display 506 and a keyboard 508. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory), ROM (read only memory), a fixed memory device (for example, hard drive), a removable memory device (for example, diskette), a flash memory and the like. In addition, the phrase “input/output interface” as used herein, is intended to include, for example, a mechanism for inputting data to the processing unit (for example, mouse), and a mechanism for providing results associated with the processing unit (for example, printer). The processor 502, memory 504, and input/output interface such as display 506 and keyboard 508 can be interconnected, for example, via bus 510 as part of a data processing unit 512. Suitable interconnections, for example via bus 510, can also be provided to a network interface 514, such as a network card, which can be provided to interface with a computer network, and to a media interface 516, such as a diskette or CD-ROM drive, which can be provided to interface with media 518.

Accordingly, computer software including instructions or code for performing the methodologies of the invention, as described herein, may be stored in associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 502 coupled directly or indirectly to memory elements 504 through a system bus 510. The memory elements can include local memory employed during actual implementation of the program code, bulk storage, and cache memories which provide temporary storage of at least some program code in order to reduce the number of times code must be retrieved from bulk storage during implementation.

Input/output or I/O devices (including, but not limited to, keyboards 508, displays 506, pointing devices, and the like) can be coupled to the system either directly (such as via bus 510) or through intervening I/O controllers (omitted for clarity).

Network adapters such as network interface 514 may also be coupled to the system to enable the data processing system to become coupled to other data processing systems or remote printers or storage devices through intervening private or public networks. Modems, cable modems and Ethernet cards are just a few of the currently available types of network adapters.

As used herein, including the claims, a “server” includes a physical data processing system (for example, system 512 as shown in FIG. 5) running a server program. It will be understood that such a physical server may or may not include a display and keyboard.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It should be noted that any of the methods described herein can include an additional step of providing a system comprising distinct software modules embodied on a computer readable storage medium; the modules can include, for example, any or all of the components detailed herein. The method steps can then be carried out using the distinct software modules and/or sub-modules of the system, as described above, executing on a hardware processor 502. Further, a computer program product can include a computer-readable storage medium with code adapted to be implemented to carry out at least one method step described herein, including the provision of the system with the distinct software modules.

In any case, it should be understood that the components illustrated herein may be implemented in various forms of hardware, software, or combinations thereof, for example, application specific integrated circuit(s) (ASICS), functional circuitry, an appropriately programmed digital computer with associated memory, and the like. Given the teachings of the invention provided herein, one of ordinary skill in the related art will be able to contemplate other implementations of the components of the invention.

Additionally, it is understood in advance that implementation of the teachings recited herein are not limited to a particular computing environment. Rather, embodiments of the present invention are capable of being implemented in conjunction with any type of computing environment now known or later developed.

For example, cloud computing is a model of service delivery for enabling convenient, on-demand network access to a shared pool of configurable computing resources (for example, networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (for example, country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (for example, storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (for example, web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (for example, host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (for example, mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (for example, cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

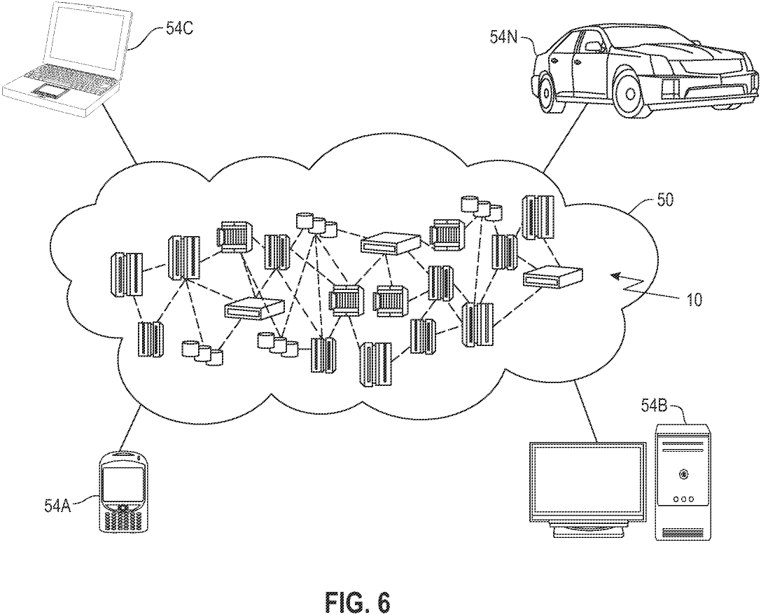

Referring now to FIG. 6, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 10 and cloud computing environment 50 can communicate with any type of computerized device over any type of network and/or network addressable connection (e.g., using a web browser).

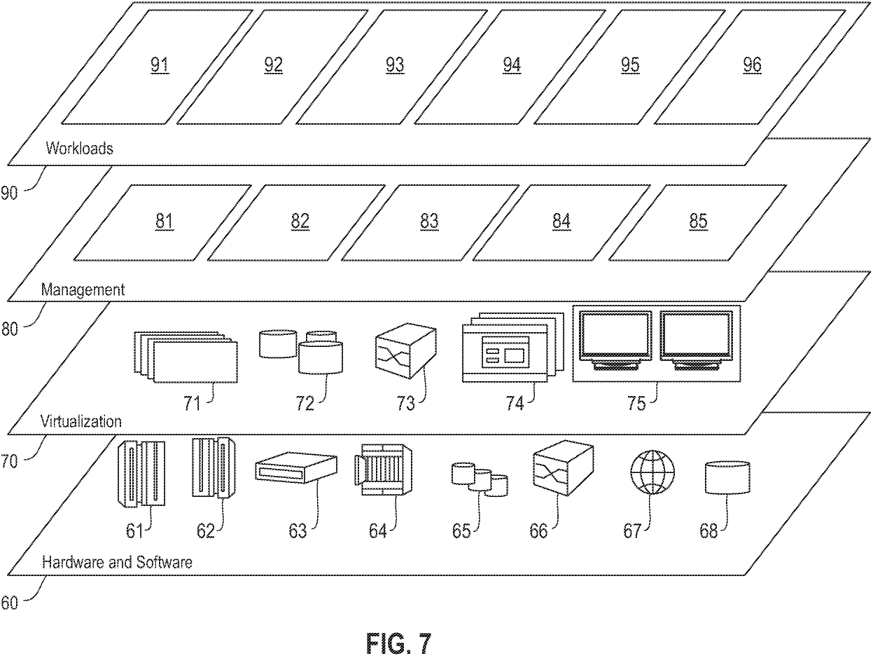

Referring now to FIG. 7, a set of functional abstraction layers provided by cloud computing environment 50 (FIG. 6) is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75. In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources.

In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and factsheet generation 96, in accordance with the one or more embodiments of the present invention.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of another feature, step, operation, element, component, and/or group thereof.

At least one embodiment of the present invention may provide a beneficial effect such as, for example, automatically generating factsheets for artificial intelligence-based question answering systems.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
processing at least one given artificial intelligence-based question answering system on tabular data using at least one test engine;
generating, based at least in part on the processing of the at least one given artificial intelligence-based question answering system, one or more accuracy values attributed to the at least one given artificial intelligence-based question answering system in connection with particular tabular data;
generating, based at least in part on the processing of the at least one given artificial intelligence-based question answering system, a set of one or more queries determined to be addressable by the at least one given artificial intelligence-based question answering system on the particular tabular data;
generating, based at least in part on the one or more accuracy values and the one or more queries determined to be addressable, at least one human-readable summary of the at least one given artificial intelligence-based question answering system; and
performing one or more automated actions based at least in part on the at least one human-readable summary;
wherein the method is carried out by at least one computing device.

2. The computer-implemented method of claim 1, wherein processing at least one given artificial intelligence-based question answering system on tabular data using at least one test engine comprises processing multiple artificial intelligence-based question answering systems on the tabular data using the at least one test engine; and
wherein generating, based at least in part on the processing of the multiple artificial intelligence-based question answering systems, a set of one or more queries comprises generating a universal test bed of queries determined to be addressable by the multiple artificial intelligence-based question answering systems.

3. The computer-implemented method of claim 2, further comprising:
comparing performance of the multiple artificial intelligence-based question answering systems in connection with the universal test bed of queries.

4. The computer-implemented method of claim 1, wherein performing the one or more automated actions comprises automatically generating, based at least in part on the at least one human-readable summary, one or more application programming interfaces associated with the at least one given artificial intelligence-based question answering system.

5. The computer-implemented method of claim 4, wherein generating one or more application programming interfaces associated with the at least one given artificial intelligence-based question answering system comprises generating at least one application programming interface pertaining to search operations with respect to the at least one given artificial intelligence-based question answering system, the particular tabular data, and one or more natural language queries.

6. The computer-implemented method of claim 4, wherein generating one or more application programming interfaces associated with the at least one given artificial intelligence-based question answering system comprises generating at least one application programming interface pertaining to obtaining training data for at least one of the at least one given artificial intelligence-based question answering system and the particular tabular data.

7. The computer-implemented method of claim 4, wherein generating one or more application programming interfaces associated with the at least one given artificial intelligence-based question answering system comprises generating at least one application programming interface pertaining to modifying the at least one given artificial intelligence-based question answering system with respect to the particular tabular data.

8. The computer-implemented method of claim 1, wherein performing the one or more automated actions comprises training the at least one given artificial intelligence-based question answering system based at least in part on at least a portion of the at least one human-readable summary.

9. The computer-implemented method of claim 1, wherein processing the at least one given artificial intelligence-based question answering system on tabular data using at least one test engine comprises testing the at least one given artificial intelligence-based question answering system on the particular tabular data using multiple questions of varying complexity.

10. The computer-implemented method of claim 1, wherein automatically generating the at least one human-readable summary comprises determining and outputting one or more suggestions for improving the at least one given artificial intelligence-based question answering system.

11. The computer-implemented method of claim 1, wherein generating the one or more accuracy values comprises generating at least one accuracy value measured on at least one standardized test set of natural language questions.

12. The computer-implemented method of claim 1, wherein performing the one or more automated actions comprises automatically updating, based at least in part on the at least one human-readable summary, one or more existing application programming interfaces associated with the at least one given artificial intelligence-based question answering system.

13. The computer-implemented method of claim 1, wherein software implementing the method is provided as a service in a cloud environment.

14. A computer program product comprising a computer readable storage medium having program instructions embodied therewith, the program instructions executable by a computing device to cause the computing device to:
process at least one given artificial intelligence-based question answering system on tabular data using at least one test engine;
generate, based at least in part on the processing of the at least one given artificial intelligence-based question answering system, one or more accuracy values attributed to the at least one given artificial intelligence-based question answering system in connection with particular tabular data;
generate, based at least in part on the processing of the at least one given artificial intelligence-based question answering system, a set of one or more queries determined to be addressable by the at least one given artificial intelligence-based question answering system on the particular tabular data;
generate, based at least in part on the one or more accuracy values and the one or more queries determined to be addressable, at least one human-readable summary of the at least one given artificial intelligence-based question answering system; and
perform one or more automated actions based at least in part on the at least one human-readable summary.

15. The computer program product of claim 14, wherein performing the one or more automated actions comprises automatically generating, based at least in part on the at least one human-readable summary, one or more application programming interfaces associated with the at least one given artificial intelligence-based question answering system.

16. The computer program product of claim 15, wherein generating one or more application programming interfaces associated with the at least one given artificial intelligence-based question answering system comprises generating at least one application programming interface pertaining to search operations with respect to the at least one given artificial intelligence-based question answering system, the particular tabular data, and one or more natural language queries.

17. The computer program product of claim 15, wherein generating one or more application programming interfaces associated with the at least one given artificial intelligence-based question answering system comprises generating at least one application programming interface pertaining to obtaining training data for at least one of the at least one given artificial intelligence-based question answering system and the particular tabular data.

18. The computer program product of claim 15, wherein generating one or more application programming interfaces associated with the at least one given artificial intelligence-based question answering system comprises generating at least one application programming interface pertaining to modifying the at least one given artificial intelligence-based question answering system with respect to the particular tabular data.

19. The computer program product of claim 14, wherein performing the one or more automated actions comprises training the at least one given artificial intelligence-based question answering system based at least in part on at least a portion of the at least one human-readable summary.

20. A system comprising:
a memory configured to store program instructions; and
a processor operatively coupled to the memory to execute the program instructions to:
process at least one given artificial intelligence-based question answering system on tabular data using at least one test engine;
generate, based at least in part on the processing of the at least one given artificial intelligence-based question answering system, one or more accuracy values attributed to the at least one given artificial intelligence-based question answering system in connection with particular tabular data;
generate, based at least in part on the processing of the at least one given artificial intelligence-based question answering system, a set of one or more queries determined to be addressable by the at least one given artificial intelligence-based question answering system on the particular tabular data;
generate, based at least in part on the one or more accuracy values and the one or more queries determined to be addressable, at least one human-readable summary of the at least one given artificial intelligence-based question answering system; and
perform one or more automated actions based at least in part on the at least one human-readable summary.
